(19) United States
(12) Patent Application Publication
(10) Pub. No.: US 2025/0164259 A1
(43) Pub. Date: May 22, 2025

(54) METHOD FOR GENERATING DETOUR ROUTE AND SYSTEM THEREOF

(71) Applicant: HYUNDAI AUTOEVER CORP., Seoul (KR)

(72) Inventors: Ye Won SEOL, Seoul (KR); Won Mi AHN, Seoul (KR); Hwa Hyeon HONG, Seoul (KR); Moon Jeong KIM, Seoul (KR); Yeon Su KIM, Seoul (KR)

(21) Appl. No.: 18/949,660

(22) Filed: Nov. 15, 2024

(30) Foreign Application Priority Data
Nov. 16, 2023 (KR) 10-2023-0158736

(51) Int. Cl. G01C 21/34

(52) U.S. Cl. CPC G01C 21/3469

(57) ABSTRACT

Methods, systems and servers for generating detour route are described. According to one embodiment, a method comprises generating a detour route comprises collecting an energy efficiency influence factor for an initial route provided to a navigation device from an external environment server, generating a detour route different from the initial route based on the energy efficiency influence factor, and providing the detour route.

### STATEMENT REGARDING PRIOR DISCLOSURES BY THE INVENTORS

A non-patent literature entitled, “A Study of Electric Vehicle Navigation UX Utilizing Netnography and TeB Methodology,” which was published on or around Jun. 23, 2023, is not prior art under 35 U.S.C. 102(b) as being a disclosure made directly or indirectly by the inventor or a joint inventor 1 year or less before the effective filing date of the instant application. A copy of the non-patent literature prior disclosure is being submitted with the instant application in an Information Disclosure Statement pursuant to 37 CFR 1.97 and 1.98.

### CROSS-REFERENCE TO RELATED APPLICATION

This application claims priority from Korean Patent Application No. 10-2023-0158736filed on Nov. 16, 2023 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method for generating a detour route and a system thereof, and more particularly, to a method for generating a detour route in consideration of energy efficiency and a system for performing the same.

### 2. Description of the Related Art

A route provided to a user by a navigation system may be a route in which information on a movement time to a destination, an operating fee, and the like, is optimized. Alternatively, the navigation system may simultaneously provide a route considering only the movement time to the destination and a route considering only the operating fee to the user.

However, the information on the movement time and the operating fee may be only some of factors considered in the route generated by the navigation device. That is, actually, user's needs are not widely reflected in the route generated by the navigation device.

Accordingly, there is a need to provide a method for generating a detour route in which new consideration factors that are not provided by an existing navigation system are reflected.

### SUMMARY

Aspects of the present disclosure provide a method for generating a detour route capable of providing a new standard to a navigation device in generating a route, and a system for performing the same.

Aspects of the present disclosure also provide a method for generating a detour route capable of providing a route considering energy efficiency to a user as a detour route, and a system for performing the same.

Aspects of the present disclosure also provide a method for generating a detour route using a travel record of another vehicle, and a system for performing the same.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a method of a navigation device for generating a detour route. The method for generating a detour route comprises collecting an energy efficiency influence factor for an initial route provided from an external environment server, generating a detour route different from the initial route based on the energy efficiency influence factor, and providing the detour route.

In some embodiments, the energy efficiency may influence factor includes a terrain information on the initial route and a road state information of a road included in the initial route.

In some embodiments, the terrain information on the initial route may include information on an elevation difference of the road included in the initial route.

In some embodiments, the road state information may include roughness information of a surface of the road.

In some embodiments, the generating of the detour route different from the initial route may be based on the energy efficiency influence factor includes obtaining the energy efficiency influence factor for the initial route from the external environment server, obtaining an energy efficiency influence factor according to a travel record of another vehicle on the initial route, and generating the detour route different from the initial route in at least some sections using the energy efficiency influence factor obtained from the external environment server and the energy efficiency influence factor according to the travel record of another vehicle.

In some embodiments, the energy efficiency influence factor according to the travel record of the another vehicle may include a brake information, a speed information, and a system use amount information.

In some embodiments, the brake information may include information on the number of times of stepping on a brake.

In some embodiments, the speed information may include an information of a speed at which an energy efficiency of a vehicle is lowest.

In some embodiments, the system use amount information may include a heater operation information, a heating wire operation information, and an air conditioner operation information.

In some embodiments, the providing of the detour route may include displaying an expected comparison result between the initial route and the detour route, receiving a user input for the detour route based on the expected comparison result, and displaying a detour route information received from the user input.

In some embodiments, the expected comparison result between the initial route and the detour route may be generated based on an energy efficiency information, a state of charge (SOC) change amount information, a distance information, a time information, and a fee information of the initial route or the detour route.

In some embodiments, the expected comparison result between the initial route and the detour route may include a guide information based on the energy efficiency information, the SOC change amount information, the distance information, the time information, and the fee information of the initial route or the detour route, and wherein, the guide information includes an appropriate speed information and a regenerative braking level information.

In some embodiments, the displaying of the detour route information received from the user input, a comparison result between the initial route and the detour route is displayed, and wherein, the comparison result is generated based on a difference from the expected comparison result.

In some embodiments, the method further may collecting a satisfaction evaluation information of the user for the detour route, modifying the initial route based on the satisfaction evaluation information and providing the initial route modified based on the satisfaction evaluation information.

In some embodiments, the modifying of the initial route based on the satisfaction evaluation information may include modifying the detour route as the initial route when a value of the satisfaction evaluation information is equal to or greater than a first reference value.

In some embodiments, the satisfaction evaluation information collected from the user refers to a satisfaction for the detour route compared to the initial route may be provided by the navigation device, and wherein, when an energy efficiency for the detour route is lower than an energy efficiency for the initial route, the value of the satisfaction evaluation information is set to be less than the first reference value.

According to an aspect of the present disclosure, there is provided a system for generating a detour route, performed by at least one processor and a memory storing instructions therein, wherein the at least one processor executes the instructions to perform an operation of collecting an energy efficiency influence factor for an initial route provided to a navigation device from an external environment server, an operation of generating a detour route different from the initial route based on the energy efficiency influence factor; and an operation of providing the detour route.

In some embodiments, the operation of generating the detour route different from the initial route based on the energy efficiency influence factor may includes an operation of obtaining the energy efficiency influence factor for the initial route from the external environment server, an operation of obtaining an energy efficiency influence factor according to a travel record of another vehicle on the initial route, and an operation of generating the detour route different from the initial route in at least some sections using the energy efficiency influence factor obtained from the external environment server and the energy efficiency influence factor according to the travel record of the another vehicle.

In some embodiments, the operation of providing the detour route may include an operation of displaying an expected comparison result between the initial route and the detour route, an operation of receiving a user input for the detour route based on the expected comparison result and an operation of displaying a detour route information received from the user input.

According to an aspect of the present disclosure, there is provided a server for generating a detour route, performed by a communication interface, a memory into which a computer program is loaded, and at least one processor executing the computer program, wherein the computer program includes an operation of collecting an energy efficiency influence factor for an initial route provided to a navigation device from an external environment server, an operation of generating a detour route different from the initial route based on the energy efficiency influence factor, and an operation of providing the detour route.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a configuration diagram of a system for generating a detour route according to an exemplary embodiment of the present disclosure;

FIG. 2 is a flowchart illustrating a process of providing a detour route generated based on energy efficiency influence factors to a user;

FIG. 3 is a detailed flowchart illustrating a process in which a service server generates a detour route based on energy efficiency influence factors received from an external environment server;

FIG. 4 is a detailed flowchart illustrating that a detour route is provided to a user based on user input;

FIG. 5 is a flowchart illustrating a process in which a navigation device collects satisfaction evaluation information of the user for a detour route and providing a route based on the collected satisfaction evaluation information to the user;

FIG. 6 is an illustrative diagram illustrating satisfaction evaluation information for a detour route displayed on a screen of the navigation device; and

FIG. 7 is an illustrative hardware configuration diagram of a computing system according to some exemplary embodiments of the present disclosure.

### DETAILED DESCRIPTION OF THE EMBODIMENTS

[1] Hereinafter, preferred embodiments of the present disclosure will be described with reference to the attached drawings. The advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.
[2] In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.
[3] Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.
[4] In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.
[5] The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.
[6] Hereinafter, some embodiments of the present disclosure will be described in detail with reference to the accompanying drawings.

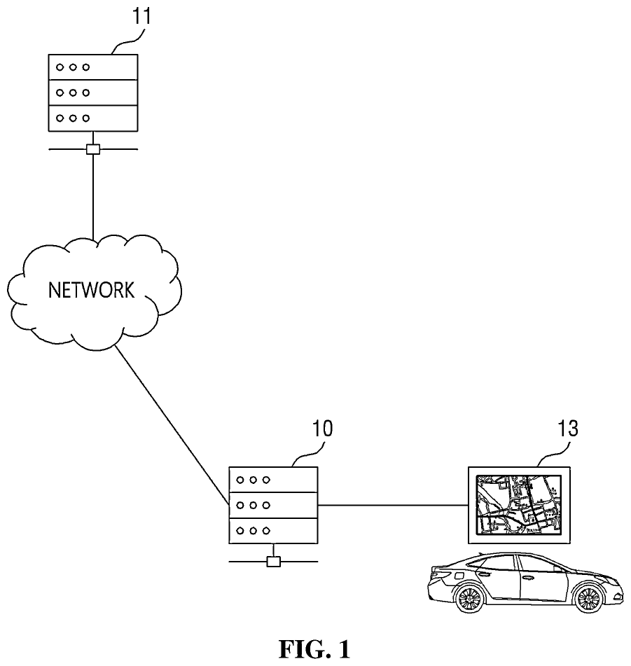

FIG. 1 is a configuration diagram of a system for generating a detour route according to an exemplary embodiment of the present disclosure.

As illustrated in FIG. 1, a latest map data download system may include a service server 10, an external environment server 11, and a navigation device 12.

First, the service server 10 may transmit initial route information to a destination set by a user to the navigation device 12 or may generate a detour route different from an initial route in at least some sections and transmit detour route information to the navigation device 12.

In this case, the detour route may be generated by the service server 10 based on energy efficiency influence factor data and vehicle state information provided by the external environment server 11. When a vehicle travels using the newly generated detour route, there may be an advantage in energy efficiency compared to when the vehicle travels using an existing initial route.

As described above, the detour route may be different from the initial route in at least some sections. The initial route may include a plurality of sections, and it may be understood that at least some of a plurality of sections included in the detour route and the plurality of sections included in the initial route are different from each other.

Specifically, the energy efficiency influence factor data may be stored in the external environment server 11, and may include, for example, terrain information, road information, traffic situation information, slope information, and weather information. However, this is only an example, and the energy efficiency influence factor data may include all data having an influence on energy efficiency.

Next, the vehicle state information, which is an energy efficiency influence factor according to a travel record of another vehicle, may be stored in the external environment server 11, and may include, for example, brake information, speed information, system use amount information, and the like. However, this is only an example, and the vehicle state information may include information related to all vehicle states having an influence on energy efficiency.

Finally, the navigation device 12 may receive information on the initial route and the detour route from the service server 10, and may also receive user input for the initial route or the detour route. In addition, the information on the initial route or the detour route may be displayed in detail on a screen of the navigation device based on the user input.

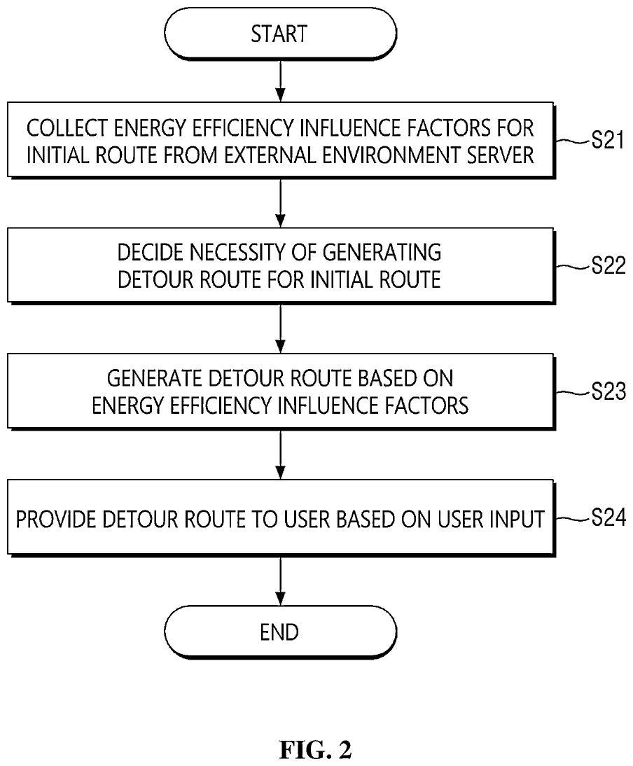

FIG. 2 is a flowchart illustrating a process of providing a detour route generated based on energy efficiency influence factors to a user.

In S21, the service server may collect energy efficiency influence factors for the initial route from the external environment server. According to an exemplary embodiment of the present disclosure, the energy efficiency influence factors may include terrain information, road information, traffic situation information, slope information, weather information, and the like, on the initial route that the navigation device provides to the user. However, as described above, this is only an example, and the energy efficiency influence factor data may include all data having an influence on energy efficiency.

Specifically, the terrain information on the initial route among the energy efficiency influence factors may include information on an elevation difference of a road included in the initial route. For example, the energy efficiency may decrease in a mountainous area with high terrain undulation compared to an area with low terrain undulation. Accordingly, the service server may collect the information on the elevation difference of the road from the external environment server and generate a detour route in which the energy efficiency is considered.

Next, the road information on the initial route among the energy efficiency influence factors may refer to roughness information of a road surface of a road on the initial route. In this case, the roughness information of the road surface may refer to information on roughness of the road surface of the road.

For example, when the road surface of the road is rough, the energy efficiency may decrease due to great frictional force compared to when the road surface of the road is smooth. Accordingly, the service server may collect road surface information of the road from the external environment server and generate a detour route in which the energy efficiency is considered.

Next, the traffic situation information on the initial route among the energy efficiency influence factors may refer to traffic congestion information on the initial route. For example, when a value of the traffic congestion information is high, the energy efficiency may decrease due to traffic congestion compared to when the value of the traffic congestion information is low. Accordingly, the service server may collect the traffic congestion information of the road from the external environment server and generate a detour route in which the energy efficiency is considered.

Next, the slope information on the initial route among the energy efficiency influence factors may refer to slope gradient information on the initial route. For example, when a value of gradient information is high, the energy efficiency may decrease compared to when the value of the gradient information is low. Accordingly, the service server may collect the slope gradient information from the external environment server and generate a detour route in which the energy efficiency is considered.

Next, the weather information on the initial route among the energy efficiency influence factors may refer to temperature information and precipitation information of the weather on the initial route. For example, when a temperature drops, gasoline is difficult to vaporize, such an amount of fuel injected into an engine increases more than usual, and thus, the energy efficiency may decrease. Accordingly, the service server may collect the temperature information and the precipitation information from the external environment server and generate a detour route in which the energy efficiency is considered.

In S22, the service server may decide the necessity of generating the detour route for the initial route. In order to generate the detour route, a process of collecting the energy efficiency influence factors and a calculation process for calculating energy efficiency are performed, and thus, it may be reasonable to generate the detour route only when necessary.

For example, the necessity of generating the detour route may be decided based on energy efficiency for the initial route and a current state of charge (SOC) amount of a vehicle.

Specifically, the energy efficiency for the initial route may be calculated from the service server. In addition, when the calculated energy efficiency is less than a first reference value, the detour route different from the initial route may be generated, but when the calculated energy efficiency is the first reference value or more, the detour route may not be generated.

That is, the necessity of generating the detour route may be decided based on the energy efficiency for the initial route, and when the calculated energy efficiency is the first reference value or more, the detour route may not be generated and the service server may collect the energy efficiency influence factors again from the external environment server.

This is because before the service server generates the detour route using the energy efficiency factors and the vehicle state information collected from the external environment server, when the energy efficiency for the initial route is not bad, the initial route may be used instead of the detour route, and thus, the generation of the detour route may be omitted.

Accordingly, when the energy efficiency for the initial route is good, only the information on the initial route may be provided to the navigation device without needing to generate the detour route, such that a navigation service may be more quickly provided to the user and an unnecessary calculation process may be omitted.

Specifically, the SOC amount in the vehicle may be calculated from the service server. In addition, when the calculated SOC amount is less than a second reference value, the detour route different from the initial route may be generated. When the calculated SOC amount is the second reference value or more, the detour route may not be generated.

That is, the necessity of generating the detour route may be decided based on the current SOC amount in the vehicle, and when the calculated SOC amount is the second reference value or more, the detour route may not be generated and the service server may collect the energy efficiency influence factors again from the external environment server.

Accordingly, when the SOC amount in the vehicle is sufficient, only the information on the initial route may be provided to the navigation device without needing to generate the detour route, such that a navigation service may be more quickly provided to the user and an unnecessary calculation process may be omitted.

In S23, the service server may generate the detour route based on the energy efficiency influence factors collected in S21. In this case, the detour route may be different from the initial route. Specifically, the initial route may be a route based on a movement time or an operating fee without considering the energy efficiency, while the detour route may be a route generated in consideration of the energy efficiency.

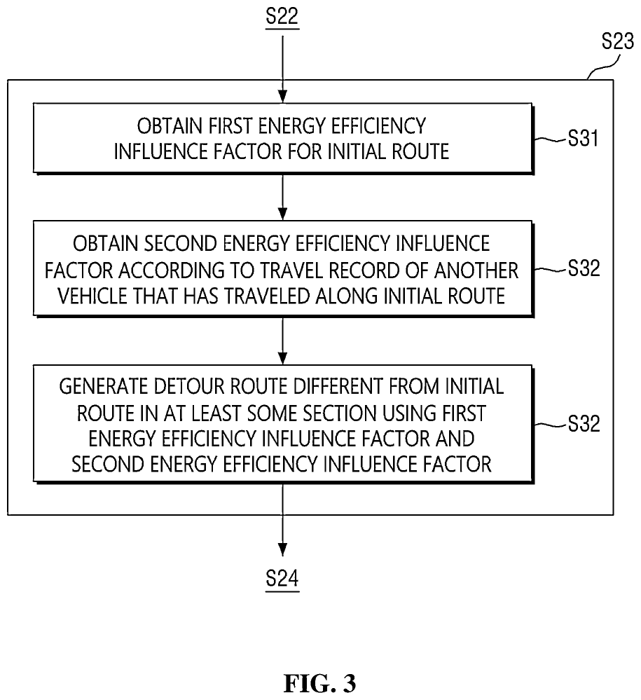

Alternatively, the detour route may be generated in consideration of the movement time or the operating fee as well as the energy efficiency. Contents related to the generation of the detour route will be described later in detail with reference to FIG. 3.

In S24, the navigation device may provide the detour route to the user based on user input. In this case, the navigation device may provide the information on the initial route as well as the information on the detour route to the user by simultaneously displaying the information on the detour route and the information on the initial route on the screen.

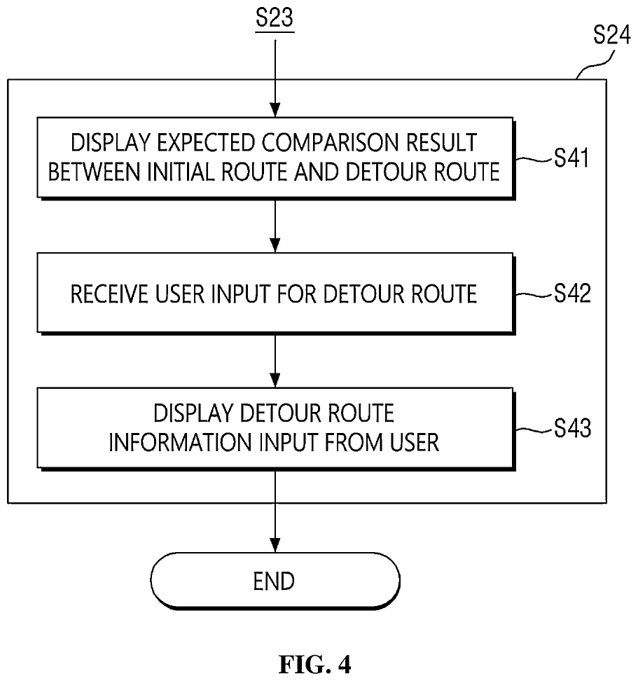

For example, the navigation device may provide a comparison result between the detour route and the initial route to the user. Specific contents related to this will be described later in detail with reference to FIG. 4.

FIG. 3 is a detailed flowchart illustrating a process in which a service server generates a detour route for the navigation device based on energy efficiency influence factors received from an external environment server.

First, in S31, the service server may obtain a first energy efficiency influence factor for the initial route from the external environment server. In this case, the first energy efficiency influence factor may include the terrain information, the road information, the traffic situation information, the slope information, the weather information, and the like, on the initial route, as described above in S21. A detailed description thereof will be omitted.

Next, in S32, the service server may receive energy efficiency and a second energy efficiency influence factor according to a travel record of another vehicle on the initial route from another vehicle. In this case, the second energy efficiency influence factor may include all consideration factors that may have an influence the energy efficiency, recorded when another vehicle travels along the initial route.

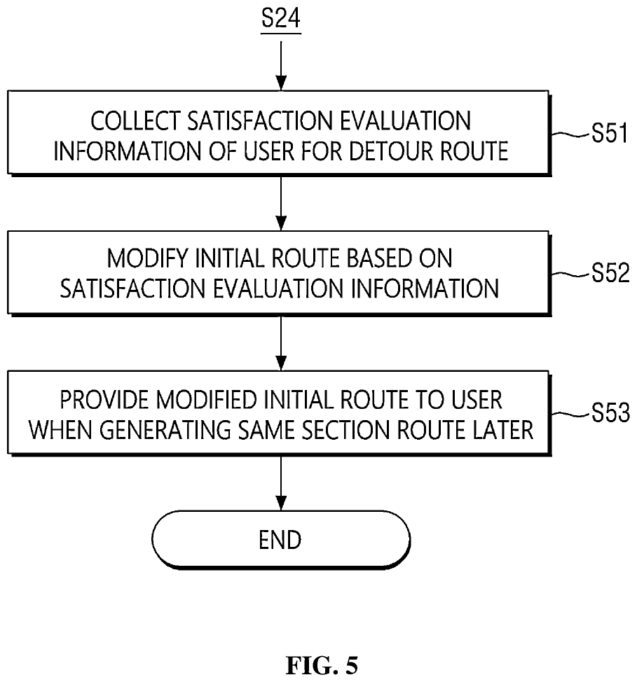

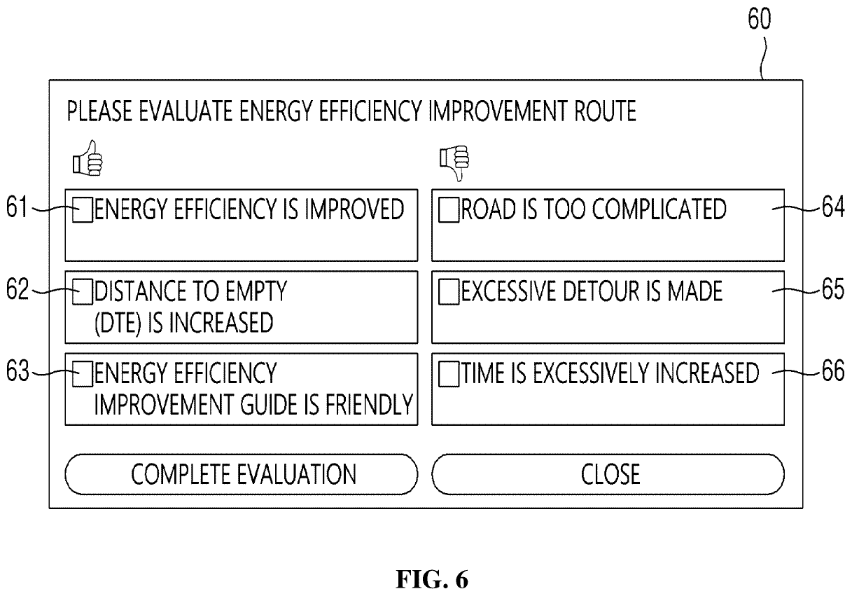

The service server may receive information on energy efficiency recorded during the travel of another vehicle along the initial route and the second energy efficiency influence factor from another vehicle on the initial route in a performance process of a satisfaction evaluation process performed when the travel along the initial route is completed. The performance of the satisfaction evaluation process will be described with reference to FIGS. 5 and 6.

For example, vehicle state information of another vehicle, such as brake information, speed information, and system use amount information, may be included in the second energy efficiency influence factor.

Specifically, the brake information among the vehicle state information may refer to information on the number of times of a brake. For example, as a result of analyzing the travel record of another vehicle along the initial route, when another vehicle travels along the initial route, in a case where a value of the information on the number of times of the brake is high, energy efficiency may decrease compared to a case where the value of the information on the number of times of the brake is low. Unless there are special circumstances, when a vehicle mounted with the navigation device travels along the initial route, it is highly likely to perform many brake operations like another vehicle. In this case, the vehicle mounted with the navigation device is also highly likely to record low energy efficiency on the initial route. Therefore, in this case, the service server may notify the navigation device of the detour route instead of the initial route.

Next, the speed information among the vehicle state information may refer to speed information on a speed at which energy efficiency is lowest. For example, when the speed at which the energy efficiency is lowest is 70 km/h, as the speed becomes closer to 70 km/h, the energy efficiency may decrease. Accordingly, the service server may obtain the speed information on the speed at which the energy efficiency is lowest from the external environment server, and notify the navigation device of the detour route instead of the initial route when an expected travel speed of the initial route is close to a speed at which energy efficiency of another vehicle is lowest.

Next, the system use amount information among the vehicle state information may include information related to whether or not a heater operates, whether or not a heating wire operates, and whether or not an air conditioner operates. For example, when the heater, the heating wire, and the air conditioner operate, the energy efficiency may decrease compared to when the heater, the heating wire, and the air conditioner do not operate. In light of this, when another vehicle on the initial route has recorded low energy efficiency and the heater and the heating wire have operated or the air conditioner has operated during the travel of another vehicle, unless there are special circumstances, the vehicle mounted with the navigation device is highly likely to record low energy efficiency like another vehicle when the heater and the heating wire operate or the air conditioner operates. Accordingly, in this case, the service server may notify the navigation device of the detour route instead of the initial route.

Next, in S33, the service server may generate the detour route different from the initial route based on the first energy efficiency influence factor obtained in S31 and the second energy efficiency influence factor obtained in S32. In addition, the detour route generated in S33 may be provided to the user based on the user input in S24.

FIG. 4 is a detailed flowchart illustrating that a detour route is provided to a user based on user input.

In S41, an expected comparison result between the initial route and the detour route may be displayed on the screen of the navigation device. In this case, the expected comparison result may be generated based on energy efficiency information, SOC change amount information, distance information, and fee information of each of the initial route and the detour route.

Specifically, an energy efficiency information difference, which is a difference between energy efficiency information when using the detour route to the destination and energy efficiency information when using the initial route provided by the navigation device, may be displayed on the screen of the navigation device.

In this case, the user may decide whether or not to select the detour route based on the energy efficiency information difference between the energy efficiency information of the detour route and the energy efficiency information of the initial route.

Next, an SOC change amount information difference, which is a difference between SOC change amount information when using the detour route to the destination and SOC change amount information when using the initial route provided by the navigation device, may be displayed on the screen of the navigation device.

In this case, the user may decide whether or not to select the detour route based on the SOC change amount information difference between the SOC change amount information of the detour route and the SOC change amount information of the initial route.

Next, a distance information difference, which is a difference between distance information when using the detour route to the destination and distance information when using the initial route provided by the navigation device, may be displayed on the screen of the navigation device.

In this case, the user may decide whether or not to select the detour route based on the distance information difference between the distance information of the detour route and the distance information of the initial route.

Next, a time information difference, which is a difference between time information when using the detour route to the destination and time information when using the initial route provided by the navigation device, may be displayed on the screen of the navigation device.

In this case, the user may decide whether or not to select the detour route based on the time information difference between the time information of the detour route and the time information of the initial route.

Next, a fee information difference, which is a difference between fee information when using the detour route to the destination and fee information when using the initial route provided by the navigation device, may be displayed on the screen of the navigation device.

In this case, the user may decide whether or not to select the detour route based on the fee information difference between the fee information of the detour route and the fee information of the initial route.

Finally, the navigation device may display guide information based on the energy efficiency information, the SOC change amount information, the distance information, the time information, and the fee information of each of the initial route and the detour route.

In this case, the guide information may include appropriate speed information and regenerative braking level information. However, this is only an example, and the guide information according to the present disclosure may include any guide that may be provided to the user through the expected comparison result between the initial route and the detour route.

In S42, the navigation device may receive user input for the detour route. Specifically, the user may select the detour route based on the expected comparison result between the initial route and the detour route provided in S41. In addition, the user may select the detour route by clicking or tapping the detour route displayed on the screen of the navigation device.

In S43, the detour route information input by the user may be displayed on the screen of the navigation device. In this case, the initial route information previously provided by the navigation device may not be displayed on the screen of the navigation device. Accordingly, only the detour route input by the user may be displayed on the screen of the navigation device.

In addition, in S43, when the detour route information input by the user is displayed on the screen of the navigation device, a comparison result between the initial route provided by the navigation device and the detour route may be displayed simultaneously. In this case, the comparison result between the initial route and the detour route may be generated based on a difference from the expected comparison result in S41 described above.

Values of the expected comparison result and an actual comparison result between the initial route and the detour route may be different from each other. Therefore, by providing a difference between the expected comparison result and the actual comparison result to the user, the user may receive more accurate information on the detour route.

FIG. 5 is a flowchart illustrating a process in which a navigation device collects satisfaction evaluation information of the user for a detour route and providing a route based on the collected satisfaction evaluation information to the user.

In S51, the user may perform a satisfaction evaluation on the detour route provided to the user in S24. In addition, the navigation device may collect satisfaction evaluation information of the user. In this case, the satisfaction evaluation of the user may be performed by comparing the detour route and the initial route with each other. Contents related to this will be described later in detail with reference to FIG. 6.

In S52, the navigation device may modify the initial route based on the satisfaction evaluation information input by the user. When a value of the satisfaction evaluation information for the detour route input by the user in S51 is a first reference value or more, the detour route may be modified as the initial route.

However, when the value of the satisfaction evaluation information for the detour route input by the user is less than the first reference value, the initial route previously provided by the navigation device may not be modified.

According to another exemplary embodiment of the present disclosure, when the energy efficiency for the detour route is lower than the energy efficiency for the initial route, the value of the satisfaction evaluation information may be set to be less than the first reference value regardless of whether or not the user inputs the value of the satisfaction evaluation information. Accordingly, when the energy efficiency for the detour route is lower than the energy efficiency for the initial route, the initial route provided by the navigation device may not be modified.

This is because the satisfaction evaluation information refers to a satisfaction for the detour route compared to the initial route provided by the navigation device, and the satisfaction may be different depending on the user, but when the energy efficiency for the detour route is lower than the energy efficiency for the initial route, the detour route generated in consideration of the energy efficiency may be considered to be erroneously generated.

Accordingly, it may be determined whether or not to modify the initial route based on the satisfaction evaluation information of the user only when the energy efficiency for the detour route is higher than the energy efficiency for the initial route.

In S53, the navigation device may provide the modified initial route to the user when generating the same section route later. In this case, the modified initial route may be different from the initial route previously provided by the navigation device, and may be the detour route selected by the user input.

Accordingly, the navigation device may discard the existing initial route information and provide the newly generated detour route to the user as the initial route. In addition, in this case, when the existing initial route information is included in the new detour route information considering the energy efficiency, the existing initial route information may be provided to the user.

FIG. 6 is an illustrative diagram illustrating satisfaction evaluation information for a detour route displayed on a screen of the navigation device.

First, satisfaction evaluation information 60 for an energy efficiency improvement route, that is, the detour route, may be displayed on the screen of the navigation device. In this case, the satisfaction evaluation information 60 may include both positive items and negative items that the detour route has compared to the initial route.

For example, items of the satisfaction evaluation information 60 for the detour route may include positive items for the detour route, such as ‘energy efficiency is improved’ 61, ‘distance to empty (DTE) is increased’ 62, and ‘energy efficiency improvement guide is friendly’ 63.

Alternatively, the items of the satisfaction evaluation information 60 for the detour route may include negative items for the detour route, such as ‘road is too complicated’ 64, ‘excessive detour is made’ 65, and ‘time is excessively increased’ 66.

In this case, the user may freely perform a satisfaction evaluation on each of the positive items or the negative items as described above. In addition, the service server may determine whether or not to generate the detour route based on the satisfaction evaluation information input by the user, and may also determine whether or not to modify the initial route.

For example, when the user inputs that the energy efficiency of the detour route has been improved compared to the initial route and a distance to empty of the detour route has been increased compared to the initial route, the value of the satisfaction evaluation information may be decided to be the first reference value or more. In addition, the service server may perform a process of modifying the detour route as the initial route.

In addition, based on the modified initial route, the service server may transmit information on the modified initial route instead of information on the existing initial route provided to the navigation device.

However, the items of the satisfaction evaluation information illustrated in FIG. 6 are only examples, and a method for deriving the value of the satisfaction evaluation information based on user input for the respective items is not limited thereto.

Meanwhile, the service server may receive information on energy efficiency recorded during the travel of another vehicle along the initial route and the second energy efficiency influence factor from another vehicle on the initial route in the performance process of the satisfaction evaluation process described with reference to FIGS. 5 and 6, performed when the travel along the initial route is completed.

For example, when an evaluation completion button of the satisfaction evaluation information 60 displayed on another vehicle on the initial route is input, the information on the energy efficiency recorded during the travel of another vehicle along the initial route and the second energy efficiency influence factor may be transmitted to the service server. Generally, when a user inputs an evaluation, information on the evaluation is transmitted to the server, and thus, the information on the energy efficiency recorded in the travel route and the second energy efficiency influence factor may be naturally collected through the satisfaction evaluation for the travel route.

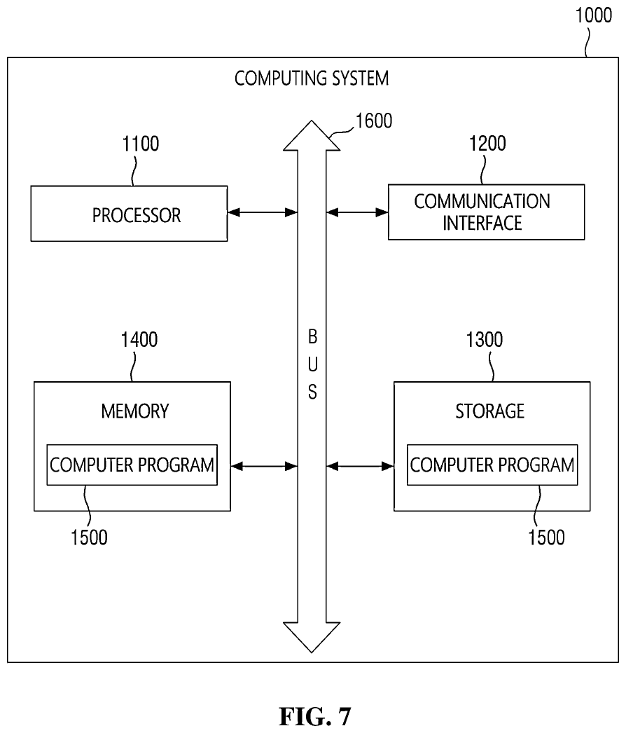

FIG. 7 is an illustrative hardware configuration diagram of a computing system 1000 according to some exemplary embodiments of the present disclosure. The computing system 1000 corresponds to the latest map data download system 10 described above.

As illustrated in FIG. 7, the computing system 1000 may include one or more processors 1100, a bus 1600, a communication interface 1200, a memory 1400 loading a computer program 1500 executed by the processor 1100, and a storage 1300 storing the computer program 1500.

However, only components related to an exemplary embodiment of the present disclosure are illustrated in FIG. 7. Accordingly, one of ordinary skill in the art to which the present disclosure pertains may know that the computing system 1000 may further include other general-purpose components in addition to the components illustrated in FIG. 7.

That is, the computing system 1000 may further include various components in addition to the components illustrated in FIG. 7. In addition, in some cases, the computing system 1000 may be configured in a form in which some of the components illustrated in FIG. 7 are omitted. Hereinafter, respective components of the computing system 1000 will be described.

The processor 1100 may control overall operations of the respective components of the computing system 1000. The processor 1100 may be configured to include at least one of a central processing unit (CPU), a micro processor unit (MPU), a micro controller unit (MCU), a graphic processing unit (GPU), a neural processing unit (NPU), or any type of processor well known in the art to which the present disclosure pertains.

In addition, the processor 1100 may perform an arithmetic operation on at least one application or program for executing operations/methods according to exemplary embodiments of the present disclosure. The computing system 1000 may include one or more processors.

Next, the memory 1400 may store various data, commands, and/or information. The memory 1400 may load the computer program 1500 from the storage 1300 in order to execute the operations/methods according to exemplary embodiments of the present disclosure. The memory 1400 may be implemented as a volatile memory such as a random access memory (RAM), but the technical scope of the present disclosure is not limited thereto.

Next, the bus 1600 may provide a communication function between the components of the computing system 1000. The bus 1600 may be implemented as various types of buses such as an address bus, a data bus, and a control bus.

Next, the communication interface 1200 may support wired/wireless Internet communication of the computing system 1000. In addition, the communication interface 1200 may support various communication methods other than the Internet communication. To this end, the communication interface 1200 may be configured to include a communication module well known in the art to which the present disclosure pertains.

Next, the storage 1300 may non-temporarily store one or more computer programs 1500. The storage 1300 may be configured to include a non-volatile memory such as a read only memory (ROM), an erasable programmable (EPROM), an electrically erasable programmable ROM (EEPROM), or a flash memory, a hard disk, a removable disk, or any type of computer-readable recording medium well known in the art to which the present disclosure pertains.

Next, the computer program 1500 may include one or more instructions for causing the processor 1100 to perform operations/methods according to various exemplary embodiments of the present disclosure when they are loaded into the memory 1400. That is, the processor 1100 may perform the operations/methods according to various exemplary embodiments of the present disclosure by executing the loaded one or more instructions.

For example, the processor 1100 may perform an instruction for collecting an energy efficiency influence factor for an initial route provided through a navigation device from an external environment server, an instruction for generating a detour route different from the initial route provided by the navigation device based on the energy efficiency influence factor, and an instruction for providing the detour route to a user based on user input for the generated detour route.

Hereinabove, the hardware configuration of the computing system 1000 according to some exemplary embodiments of the present disclosure has been described with reference to FIG. 7.

Embodiments of the present disclosure have been described above with reference to FIGS. 1 through 7, but it should be noted that the effects of the present disclosure are not limited to those described above, and other effects of the present disclosure should be apparent from the following description.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those having ordinary skill in the art should appreciate that many variations and modifications can be made to the embodiments without substantially departing from the principles of the present disclosure. Therefore, the disclosed embodiments of the present disclosure are used in a generic and descriptive sense only and not for purposes of limitation.

What is claimed is:

1. A method of a navigation device for generating a detour route, the method comprising:
collecting an energy efficiency influence factor for an initial route provided from an external environment server;
generating a detour route different from the initial route based on the energy efficiency influence factor; and
providing the detour route.

2. The method of claim 1, wherein the energy efficiency influence factor includes a terrain information on the initial route and a road state information of a road included in the initial route.

3. The method of claim 2, wherein the terrain information on the initial route includes information on an elevation difference of the road included in the initial route.

4. The method of claim 2, wherein the road state information includes a roughness information of a surface of the road.

5. The method of claim 1, wherein the generating of the detour route different from the initial route based on the energy efficiency influence factor includes:
obtaining the energy efficiency influence factor for the initial route from the external environment server;
obtaining an energy efficiency influence factor according to a travel record of another vehicle on the initial route; and
generating the detour route different from the initial route in at least some sections using the energy efficiency influence factor obtained from the external environment server and the energy efficiency influence factor according to the travel record of the another vehicle.

6. The method of claim 5, wherein the energy efficiency influence factor according to the travel record of the another vehicle includes a brake information, a speed information, and a system use amount information.

7. The method of claim 6, wherein the brake information includes information on the number of times of stepping on a brake.

8. The method of claim 6, wherein the speed information includes an information of a speed at which an energy efficiency of a vehicle is lowest.

9. The method of claim 6, wherein the system use amount information includes a heater operation information, a heating wire operation information, and an air conditioner operation information.

10. The method of claim 1, wherein the providing of the detour route includes:
displaying an expected comparison result between the initial route and the detour route;
receiving a user input for the detour route based on the expected comparison result; and
displaying a detour route information received from the user input.

11. The method of claim 10, wherein the expected comparison result between the initial route and the detour route is generated based on an energy efficiency information, a state of charge (SOC) change amount information, a distance information, a time information, and a fee information of the initial route or the detour route.

12. The method of claim 11, wherein the expected comparison result between the initial route and the detour route includes a guide information based on the energy efficiency information, the SOC change amount information, the distance information, the time information, and the fee information of the initial route or the detour route, and wherein the guide information includes an appropriate speed information and a regenerative braking level information.

13. The method of claim 10, wherein in the displaying of the detour route information received from the user input, a comparison result between the initial route and the detour route is displayed, and wherein the comparison result is generated based on a difference from the expected comparison result.

14. The method of claim 1, further comprising:
collecting a satisfaction evaluation information of the user for the detour route;
modifying the initial route based on the satisfaction evaluation information; and
providing the initial route modified based on the satisfaction evaluation information.

15. The method of claim 14, wherein the modifying of the initial route based on the satisfaction evaluation information includes modifying the detour route as the initial route when a value of the satisfaction evaluation information is equal to or greater than a first reference value.

16. The method of claim 15, wherein the satisfaction evaluation information collected from the user refers to a satisfaction for the detour route compared to the initial route provided by the navigation device, and wherein when an energy efficiency for the detour route is lower than an energy efficiency for the initial route, the value of the satisfaction evaluation information is set to be less than the first reference value.

17. A system for generating a detour route, comprising:
at least one processor; and
a memory storing instructions therein,
wherein the at least one processor executes the instructions to perform
an operation of collecting an energy efficiency influence factor for an initial route provided to a navigation device from an external environment server;
an operation of generating a detour route different from the initial route based on the energy efficiency influence factor; and
an operation of providing the detour route.

18. The system of claim 17, wherein the operation of generating the detour route different from the initial route based on the energy efficiency influence factor includes:
an operation of obtaining the energy efficiency influence factor for the initial route from the external environment server;
an operation of obtaining an energy efficiency influence factor according to a travel record of another vehicle on the initial route; and
an operation of generating the detour route different from the initial route in at least some sections using the energy efficiency influence factor obtained from the external environment server and the energy efficiency influence factor according to the travel record of the another vehicle.

19. The system of claim 17, wherein the operation of providing the detour route includes:
an operation of displaying an expected comparison result between the initial route and the detour route;
an operation of receiving a user input for the detour route based on the expected comparison result; and
an operation of displaying a detour route information received from the user input.

20. A server for generating a detour route, comprising:
a communication interface;
a memory into which a computer program is loaded; and
at least one processor executing the computer program,
wherein the computer program includes:
an operation of collecting an energy efficiency influence factor for an initial route provided to a navigation device from an external environment server;
an operation of generating a detour route different from the initial route based on the energy efficiency influence factor; and
an operation of providing the detour route.
